(19) United States
(12) Patent Application Publication
(10) Pub. No.: US 2006/0191251 A1
(43) Pub. Date: Aug. 31, 2006

(54) Harvesting machine with an adjustable chopping means

(76) Inventors: Peter Pirro, Wallhaben (DE); Christophe Debain, Saint Saturnain (FR); Bernard Benet, Lempdes (FR); Michel Berducat, Veyre Monton (FR)

Correspondence Address: DEERE & COMPANY, ONE JOHN DEERE PLACE, MOLINE, IL, 61265, US

(21) Appl. No.: 11/301,038

(22) Filed: Dec. 12, 2005

(30) Foreign Application Priority Data
Dec. 18, 2004 (EP) 04030089.9

(51) Int. Cl. A01D 45/02

(52) U.S. Cl. 56/60

(57) ABSTRACT

A harvesting machine including a chopper mechanism for cutting harvested crop into short lengths, a crop feed arrangement for feeding the harvested crop to the chopper means and a drive arrangement for driving the crop feed arrangement and the chopper means. The drive arrangement including at least one adjustable component for driving one of the crop feed arrangement or chopper means at a variable speed thereby changing the length into which the harvested crop is cut. A control device is connected to the adjustable component and to a crop parameter sensor to measure at least one parameter of the crop being harvested. The control device automatically controls the adjustable component such that the length into which crop is cut by the chopper mechanism is a function of the sensed crop parameter.

### BACKGROUND

1. Field of the Invention

The invention relates to harvesting machines and more specifically harvesting machines having an adjustable chopping mechanism.

2. Description of the Related Act

Forage harvesters, also called field choppers, employed in agriculture are used for cutting and picking up harvested crops, for example, grass or corn, which is normally used as fodder for cattle. To promote the digestibility of the fodder, the cut length of the harvested crop is very important. In current forage harvesters, mechanisms have been used for adjusting the cutting length of the chopping device wherein hydraulic motors, adjustable either continuously or in steps or shifting transmissions have been used.

U.S. Publication Number 2003/0217538 A1 A proposes to control the cut length in a forage harvester dependent on humidity or nutrient content of the crop, as measured with an optical sensor working in the near infrared range. It is further proposed that the grain content is measured optically and used for determining the length of cut. European Patent EP 1 396 184 A proposes to control the cut length in a forage harvester dependent on the compressibility of the crop.

It has also been proposed to investigate agricultural products with cameras and image processing systems in order to determine various crop parameters. U.S. Publication Number 1996/0656648 describes an image analysis of a forage sample for gaining information about the nutrient content of the forage. U.S. Pat. No. 5,309,374 proposes an image analysis for detecting the mass or shape of harvested products. U.S. Pat. No. 6,119,442 relates to a combine harvester in which threshed crop is under surveillance of a camera. The image is processed in order to detect damaged grain and to control the threshing mechanism accordingly so that grain damage is automatically reduced.

A problem with forage harvesters is that the real cutting length does not always correspond to a theoretical cutting length that is calculated from the speed with which the crop is fed to the chopper mechanism, and the speed of the chopper mechanism and the number of knives distributed around its circumference. A discrepancy may result since, for example, slippage may occur when the crop has a relatively high moisture content. The length of cut thus can depend on crop properties, such as moisture and the variety of the crop.

Therefore, there exists a need for an improved harvesting machine with a chopper mechanism such that the achieved cutting length corresponds better with the desired cutting length.

### BRIEF SUMMARY

In satisfying the above need, as well as overcoming the enumerated drawbacks and other limitations of the related art, a harvesting machine including crop feed arrangement for feeding the harvested crop to a chopper mechanism is disclosed. One or both of the chopper mechanism and the crop feed arrangement are driven at a variable speed, controlled by a control device. It is proposed that the control device is connected to a sensor providing information about a granulometric parameter of the chopped crop. The control device is operable to control the speed of the chopper mechanism and/or the crop feed arrangement such that at least one granulometric parameter (or more of them), especially the size (for example length, area or volume) of the chopped crop particles, measured with the sensor corresponds to a desired granulometric parameter. The latter can be input by an operator or automatically established by a second sensor interacting with the crop. The second sensor can measure e.g., the moisture of the crop, its nutrient content, its compressibility, and/or its grain content.

An advantage of the teaching of the invention is that the real length of cut corresponds more closely to the desired length of cut, independent of the variety and physical properties of the chopped crop. The invention can be used in particular in a forage harvester with a chopper drum as the chopper mechanism or in a combine with a straw chopper as the chopper mechanism.

In one embodiment, the sensor for measuring the size of the chopped crop comprises a camera viewing the crop stream downstream the chopper mechanism. An electronic image signal, containing two dimensional image information delivered by the camera, is processed by an image processing system in order to extract a granulometric information such as the medium size or parameters representative of the overall distribution of the chopped crop. This information is provided to the control device. Another embodiment comprises a sieve with different hole sizes and means for detecting the crop particles passing through the respective holes. From time to time, crop samples can be delivered onto the sieve. The number of crop particles passing through the different holes is counted and a mean size of the particles is established. Granulometric information after the sieving process can also be given by a camera device.

When a camera is used for detecting the crop size in situ directly above (or below or besides) the flow, a potential problem resides in the relatively high speed of the crop. One possible solution is to use a high speed, black and white or color camera synchronized with an electronic flash in order to provide light flashes upon the crop within the viewing angle of the camera. In this case, the exposure time can by controlled by the shutter performance (speed) of the camera and is independent on the time duration of the light source. In order to avoid the need of using a camera having a very high shutter speed, another embodiment using a more common camera and controlling the time duration of the electronic flash or a stroboscope is possible. As with normal photographic cameras, the flash illuminates the crop sample for a quite short time, such that a sharp image is obtained.

These and other aspects and advantages of the present invention will become apparent upon reading the following detailed description of the invention in combination with the accompanying drawings.

### BRIEF DESCRIPTION OF THE DRAWINGS

FIG. 1 is a schematic, left side elevational view of a harvesting machine with which the present invention is particularly adapted;

FIG. 2 is a schematic side view of a sensor suitable for measuring the size of chopped crop; and

FIG. 3 is a schematic illustration of a device for effecting automatic adjustment of the cutting length according to the principles of the present invention.

### DETAILED DESCRIPTION

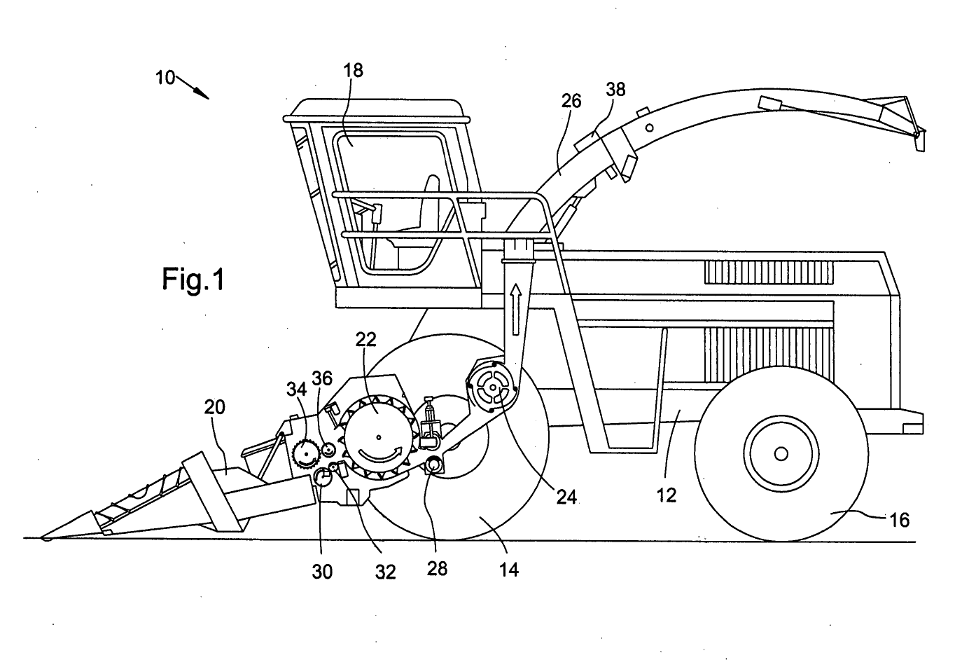

Referring to FIG. 1, a self-propelled harvesting machine 10 in the form of a forage harvester including a main frame 12 supported on front and rear wheels 14 and 16 is shown. The harvesting machine 10 is operated from a driver's cab 18, from which a harvested material pickup device 20 is visible. The crop, e.g., corn, grass or the like, is picked up from the ground by the harvested material pickup device 20, is moved by means of four front press rollers 30, 32, 34, 36 to a chopper means 22 in form of a chopper drum or cutter head, which chops the crop into small pieces and sends it to a conveyor unit 24. The material passes from the harvesting machine 10 to a rear or side trailer via a discharge chute 26, which may be adjustable about an upright axis. Located between the chopper means 22 and the conveyer unit 24 is a kernel processor device including two cooperating rollers 28, which act to feed the conveyed material tangentially to the conveyor unit 24. Upon the top surface of the discharge chute 26, a crop parameter sensor 38 is mounted.

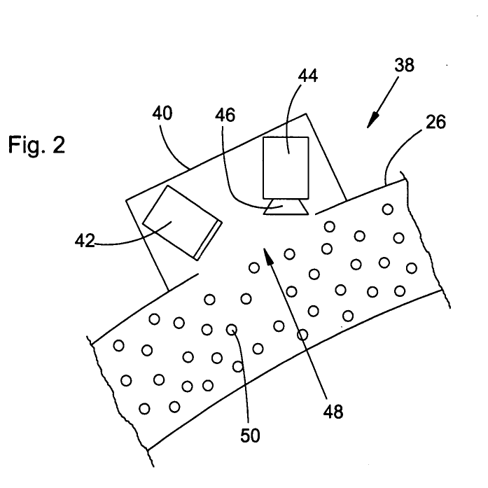

In FIG. 2, the crop parameter sensor 38 is shown in greater detail. The sensor 38 is mounted within a light-tight, protective housing 40 mounted to the discharge chute 26. Within the housing 40, a flash device 42 and an electronic camera 44 are provided. The camera 44 has a lens 46 oriented to view through an opening 48 into the interior of the discharge chute 26, such that an image of the chopped crop particles 50 flowing through the discharge chute 26 can be obtained. Another possible embodiment comprises a ring flash located around the camera lens or flash devices on both sides of the camera 44, the latter being in a plane perpendicular to the opening window 48. The flash device 42 is operable to emit subsequent flashes, e.g., in intervals of 500 ms or less, with very short time duration (10 μs or less) and coupled with operation of the camera 44, upon the chopped crop particles 50 in the viewing angle of the lens 46. Although not shown, a cover for avoiding or reducing entry of light from the circumference of the housing 40 might be provided on the discharge chute 26. Within the opening 48, a transparent screen may be provided, preferably with high scratch resistance of, for example, sapphire glass.

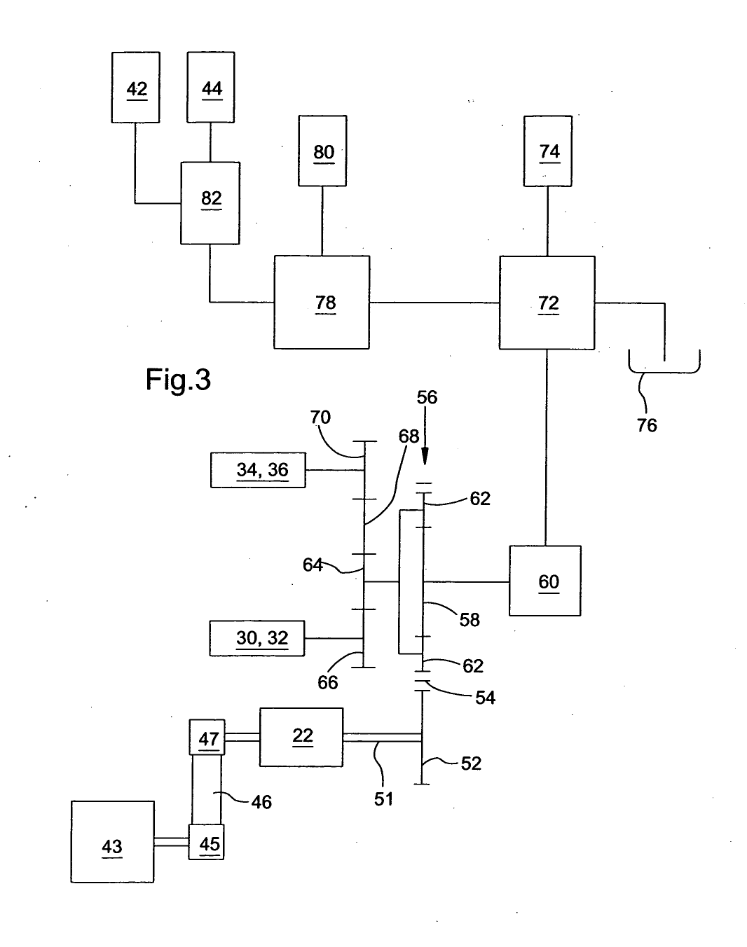

The camera 44 generates an electronic signal containing a two dimensional picture information and provides this signal to a digital image processing system 82 (FIG. 3) using a microprocessor or microcontroller. The image processing system 82 is operable to process the picture information, and derives data on granulometric characteristics of the crop particles 50 under consideration of the viewing angle between the camera 44 and the flow direction of the chopped crop particles 50. The granulometric data contains information on the particle size, such as the mean length of the chopped crop particles 50. A distinction between length and width of the particles 50 can be performed using an expected length of cut derived from the speed of the rollers 30-36 and the chopper means 22. Thus, length is considered as the one of the two measurements of the particles 50 fitting best to the expected cut length. In another embodiment, the length is simply considered as the size of the particles 50 in the flow direction within the discharge chute 26. The image processing system 82 also controls the flash device 42 and instructs it to submit a flash once processing of a previously taken image is finalized and a capacitor of the flash device 42 if sufficiently charged such that a subsequent flash can be provided.

The present invention allows comparison of the actual cut length of the chopped crop with a desired cut length and adjusting the actual cut length such that the desired cut length is obtained. As mentioned above, the cut length of the chopped crop that is ejected from the discharge chute 26 depends on the rotating speed of the front press rollers 30-36, on the speed of the chopper mechanism 22, and on the number of blades or knives attached to the chopper mechanism 22. FIG. 3 shows a detailed illustration of the drive unit for the chopper mechanism 22, the front press rollers 30-36, and the device for automatic adjustment.

An internal combustion engine 43 operating at constant speed, while in a harvest mode, drives a transmission belt 46 via a pulley 45 which includes a disengageable coupling. The transmission belt 46, in turn, drives a pulley 47 coupled to the chopper mechanism 22. The chopper mechanism 22 includes a shaft 51 which drives a cogwheel or gear 52 that is meshed with a ring gear 54 of a planetary gear train 56. The planetary gear train 56 includes a sun gear 58 coupled to a hydraulic motor 60. Planet gears 62 of the planetary gear train 56 are coupled via a planet carrier with a cogwheel or gear 64 that drives the lower front press rollers 30, 32 via an additional cogwheel or gear 66, and drives the upper front press rollers 34, 36 in a direction opposite that of the lower front press rollers, via additional cogwheels or gears 68 and 70. Due to this configuration, the chopper mechanism 22 is driven at a constant rotational speed. The rotational speed of the front press rollers 30-36 depends on the rotational speed and direction of the hydraulic motor 60. The latter serves as an adjustable component for driving a crop feed component (rollers 30-36) at a variable speed.

The hydraulic motor 60 is connected, by a valve unit 72, to a pressurized hydraulic fluid source 74 and to a hydraulic fluid supply tank 76. The valve unit 72 is also electrically connected to a control device 78 that can be actuated to control the valve unit 72 such that the hydraulic motor 60 will rotate at a rotational speed and direction specified by the control unit 78. The control unit 78 is thus suited for continuous adjustment of the cutting length of the ejected material.

The control unit 78 is also connected to an input means 80 for inputting a desired length of cut. The control unit 78, during operation, compares the desired length of cut (inputted by the operator via the input means 80) with the measured length of cut (provided by the image processing system 82) and adjusts the speed of the motor 60, by means of the valve unit 72, such that the desired cut length and the measured cut length are at least approximately equal.

The foregoing disclosure is the best mode devised by the inventor for practicing this invention. It is apparent, however, that methods incorporating modifications and variations will be obvious to one skilled in the art of such vehicles and devices. Inasmuch as the foregoing disclosure is intended to enable one skilled in the pertinent art to practice the instant invention, it should not be construed to be limited thereby, but should be construed to include such aforementioned obvious variations and be limited only by the spirit and scope of the following claims.

It should be mentioned that different modifications to the invention are possible. For example, it would be possible to use any type of (second) sensor for detecting crop properties, like the moisture, instead of, or in addition to, the input means 80, in order to establish a desired length of cut dependent on crop properties. Such a second sensor, for detecting moisture or other property, could be a microwave sensor, a capacitive sensor, an optical sensor, or a conductivity sensor. Alternatively, the protein content of the chopped crop could be measured by a second sensor operating in the near-infrared range and used for establishing a desired cut length. If several sensors are used that measure different parameters of the chopped crop, then the control unit 78 will derive a cutting length value which best fits with the combination of measured parameters. The crop parameter sensor 38 can also be located at a point on the harvesting machine 10 between the chopper mechanism 22 and the rotatable support of the discharge chute 26 on the body of the harvesting machine 10. Preferably, the operator can also switch between an automatic and a manual mode.

1. A harvesting machine comprising:
a chopper mechanism for cutting harvested crop into short lengths;
a crop feed arrangement to feed the harvested crop to the chopper mechanism;
a drive arrangement to drive the crop feed arrangement and the chopper means, the drive arrangement including at least one adjustable component driving at least one of said crop feed arrangement and chopper mechanism at a variable speed so as to change the length into which the harvested crop is cut; and
a control device connected to the adjustable component and to a crop parameter sensor, said crop parameter sensor adapted to measure at least one parameter of the crop being harvested, wherein said control device is configured to automatically control the adjustable component such that the length into which crop is cut by said chopper mechanism is a function of a sensed crop parameter, said sensor being configured to measure a granulometric parameter of the chopped crop.

2. The harvesting machine according to claim 1, wherein said crop parameter sensor is configured to measure the size of the chopped crop.

3. The harvesting machine according to claim 1, wherein said crop parameter sensor includes a camera positioned to view the chopped crop downstream said chopper mechanism, said camera providing an electronic input signal to an image processing system that is configured to derive the granulometric parameter of the chopped crop particles from said input signal.

4. The harvesting machine according to claim 3, wherein said crop parameter sensor comprises a flash device for illuminating the chopped crop within the viewing range of the camera with successive flashes.

5. The harvesting machine according to claim 4, wherein said flash device is configured to provide flashes of a controlled flash duration and synchronized with the camera.

6. A method of controlling a harvesting machine comprising the steps of:
cutting harvested crop;
feeding the harvested crop to a chopper means;
driving the crop feed arrangement and the chopper means;
driving at least one of said crop feed arrangement and chopper means at a variable speed so as to change the length into which the harvested crop is cut;
measuring at least one parameter of the chopped crop; and
controlling an adjustable component such that the length into which crop is cut by said chopper means is a function of the sensed crop parameter, wherein the crop parameter sensor measures a granulometric parameter of the chopped crop.
